(19) United States
(12) Patent Application Publication
(10) Pub. No.: US 2019/0062183 A1
(43) Pub. Date: Feb. 28, 2019

(54) ARTIFICIALLY MINERALIZED DRINKING WATER AND COMPOSITION FOR THE PREPARATION THEREOF

(71) Applicants: Vladimir L'vovich MAKAROV, St. Petersburg (RU); Hyung Rae KIM, Yongin-si, Gangnam Village (KR)

(72) Inventor: Vladimir L'vovich MAKAROV, St. Petersburg (RU)

(73) Assignees: Vladimir L'vovich MAKAROV, St. Petersburg (RU); Hyung Rae KIM, Yongin-si, Gangnam Village (KR)

(21) Appl. No.: 15/761,740

(22) PCT Filed: Jun. 1, 2016
(86) PCT No.: PCT/RU2016/000330

§ 371 Date: Mar. 20, 2018

(30) Foreign Application Priority Data
Sep. 21, 2015 (EA) 201500937

(51) Int. Cl. C02F 1/68; A23L 2/54; A23L 33/16

(52) U.S. Cl. CPC C02F 1/68; A23V 2002/00; A23L 33/16; A23L 2/54

(57) ABSTRACT

The invention relates to the field of drinking water treatment and can be used in public utilities, food industry, and medicine. The proposed artificially mineralized drinking water contains at least one water-soluble compound of magnesium and at least one water-soluble compound of zinc, the concentrations of which in equivalent to magnesium and zinc amounting to 5-65 mg/l and 1-5 mg/l, respectively. The magnesium and zinc compounds are preferably selected from chlorides and/or sulfates. The water may additionally contain water-soluble compounds of calcium, preferably calcium chloride; compounds of fluorine (with 0.1-1.5 mg/l concentration of fluorine) and/or selenium (with 2-9 mg/l concentration of selenium) and/or iodine (with 10-125 μg/l concentration of iodine), and also compounds of sodium and/or potassium, preferably their hydrogen carbonates and/or chlorides and/or sulfates. The mass ratio of magnesium to zinc is 1:0.02-1. Additionally, the composition may contain compounds of calcium, potassium and other ingredients necessary for the preparation of drinking water. The resulting artificially mineralized drinking water can be used for producing beverages and food products. The result of using the invention, i.e. using drinking water enriched with magnesium and zinc ions, is that the water produced according to the invention has a vitalizing effect on the human organism.

### SCOPE AND FIELD OF APPLICATION

The invention refers to the sphere of drinking water pre-treatment, particularly, enrichment of water with mineral additives, and can be used in water supply, food industry, and other areas for production of drinking water with well-balanced composition.

### PRIOR ART

It is known that distilled water has the best taste, and consuming this water in reasonable amounts, in the opinion of physicians and nutritionists, improves the quality of life. However, distilled water does not meet the criteria of physiological full-value established for drinking water, as it does not contain biologically necessary macro- and micro-components. The relevance of mineralized water preparation stems from the so-called “deficiency diseases” related to long-lasting insufficient consumption of macro- and micro-elements. For example, deficiency of micro-elements can cause anemia, which children and women are especially susceptible to. There also exist other diseases related to the “micro-element shortage.”

In particular, we know that at the stage of industrial treatment of drinking water, as well as most of other commercial waters and other beverages, magnesium (Mg) and zinc (Zn) are practically completely extracted from their composition. At the same time, magnesium and zinc, along with iron, copper, calcium, iodine, and selenium belong to the elements the deficiency of which is most frequently registered in industrially developed countries. Thus, about 60% of men and 80% of women have magnesium deficiency. Approximately the same percentage ratios are registered regarding zinc. It is obvious that this deficiency is not related to any particular endemic specificities of an area, as it is, for example, the case with iodine deficiency in the Swiss Alps or with calcium deficiency in Iceland, Sweden, and Norway, but results from the “industrialization” of food and drinking water treatment.

Nonetheless, magnesium and zinc deficiency in the human organism can cause significant influence on both physical and psychoemotional states of a human being. It is known that, for example, zinc participates in the synthesis of about 200 enzymes, while magnesium—of 300. Deficiency of one of the elements can lead to a dysfunction of the entire enzyme system and be the cause of numerous diseases, as well as of depressive states and other psychoemotional disorders.

At the same time, at the prior technical level, there are very few recommendations on the use of mineralized alternatives of drinking water, especially of those containing the above-mentioned metals in amounts necessary for general strengthening and revitalizing influence on the human organism and for maintaining of the overall physical and psychoemotional state of a human being in health.

We know of the water produced in accordance with technical specification TS 6-09-3457-83 “The composition of salts for preparation of drinking water from distillate”, according to which 480 g of sodium hydrogen sulfate, 406 g of magnesium sulfate heptahydrate, 1610 g of calcium chloride, 1313 g of sodium bicarbonate, and 9 g of sodium fluoride are added to each 5 tons of distilled water.

From the indicated salt composition added to distilled water in accordance with the TS it follows that enhanced content of calcium ions appears in the water; besides, a huge amount of sodium ions is additionally added. It is well known that calcium and magnesium are antagonists and they practically “block” each other in the organism; for this reason, quite a noticeable reduction of the removal of these elements from the organism is taking place, while calcium is deposited in the form of salts in the body organs and articulation joints. Besides, the indicated in TS composition for preparation of mineralized water contains no zinc components, while the content of magnesium is far from optimal in terms of corresponding to physiological body needs and it does not help decreasing risks of distresses and psychoemotional disorders.

A method for producing drinking water from distilled water through adding potassium sulfate and magnesium sulfate is known (RF Patent No 22051125, 1995). This method allows to produce water physiologically balanced by potassium and magnesium salts. The qualitative and quantitative salt composition added to the water, as described in the RF Patent No 22051125, allows to produce water well ingested in the body and with enhanced capacity of removing waste products out of it. However, one should not be using only this type of water as it lacks physiologically necessary zinc components. Moreover, similar to the preceding analogue, the content of magnesium in the composition is not optimal either, which, taken together, does not allow to produce any noticeable impact on both physical and psychoemotional states of human beings.

There is a well-known artificially mineralized drinking water and the composition for its preparation (RF Patent No 22134241, 1999). This water includes at least one compound of calcium, magnesium, and iodine with concentrations in equivalent to calcium, magnesium, and iodine being 20-150, 8-120 and 0.01-0.15 mg/l, respectively. In particular cases, calcium and magnesium compounds are selected from the water-soluble sulfates and/or citrates. In addition, the water contains at least one potassium compound, one zinc compound, and one manganese compound. Per totality of essential features and the result achieved, this well-known water and the composition for its preparation are the closest analogues of the proposed group of inventions. As drawbacks of the artificially mineralized drinking water and the prototype composition (RF Patent No 22134241) we can consider the incomplete correspondence of its composition to the physiological requirements of the organism, as well as limited capacities for decreasing risks of distresses and psychoemotional disorders.

Essence of Invention

The task to be solved by this invention is enrichment of drinking water with mineral additions in an easy-to-ingest, well-balanced, and accessible form for provision of its general tonic and healthful impact on the human body, including enhancement of the organism's resistance in stressful situations.

The technical result achieved by the claimed invention consists of the improvement of the water quality by providing a well-balanced content of the necessary components to ensure that the water composition meets the physiological and psychoemotional needs of the organism, including enhancement of the organism's resistance in stressful situations.

For the solution of the problem set and achievement of the indicated result, a group of inventions united by a holistic inventive approach is proposed.

One of the aspects of the proposed group of inventions is the artificially mineralized drinking water containing water and water-soluble compounds of magnesium and zinc, distinct from the prototype in that it contains at least one magnesium compound and one zinc compound, with concentrations of Mg and Zn being 5-65 mg/l and 1-5 mg/l, respectively.

Additional distinction of the proposed water is that it contains chlorides and/or sulfates as water-soluble compounds of magnesium and zinc, while the concentration of magnesium is 30-50 mg/l, and the concentration of zinc is 3-5 mg/l.

In accordance with one of the variants of implementation of the invention claimed, the artificially mineralized water additionally contains at least one calcium compound with concentration in equivalent to calcium amounting to 10-100 mg/l, while the concentration of magnesium may amount to 35-45 mg/l, of zinc—to 3.5-4.5 mg/l, and of calcium—to 70-90 mg/l.

Other additional distinctions of the invention claimed are that the water additionally contains at least one fluorine compound with concentration in equivalent to fluorine amounting to 0.1-1.5 mg/l, and also may additionally contain at least one selenium compound, with concentration in equivalent to selenium amounting to 2-9 μg/l.

In addition to the above-mentioned options of realization, the artificially mineralized drinking water of this invention can additionally contain at least one iodine compound, with concentration in equivalent to iodine being 10-125 μg/l; and also it can additionally contains water-soluble compounds of sodium and/or potassium, preferably their hydrogen carbonates and/or chlorides and/or sulfates, and/or water-dissolved oxygen or carbon dioxide.

The proposed artificially mineralized drinking water is produced by altering of the number and/or concentrations of the compounds of the chemical elements present in the natural or partially or completely demineralized water. In particular cases, the water is used for producing beverages or food products. In a particular case, the water additionally contains at least one component of a tonic and/or flavored and/or vitamin-fortified beverage and/or at least one flavoring agent and/or at least one food coloring and/or at least one food preservative.

The claimed technical result is also achieved by the use of the composition, based on water-soluble compounds of magnesium and zinc, to produce artificially mineralized water from the initial low-mineralized water or completely or partially demineralized water, differing from the prototype by containing at least one compound of magnesium and one zinc compound, the mass ratio of magnesium to zinc being 1:0.02-1.

In a particular case of implementing the invention, sulfates of magnesium and zinc are used as water-soluble compounds of magnesium and zinc; at that, preferably, the compound contains 4.9 g of zinc sulfate per 100 g of magnesium sulfate.

In another variant of the composition implementation, according to the invention claimed, chlorides of magnesium and zinc are used as water-soluble compounds of magnesium and zinc; at that, preferably, the composition contains 5.3 g of zinc chloride per 100 g of magnesium chloride.

Other additional distinctions of the invention claimed are that in addition to the above said, the composition may contain at least one compound of calcium, the mass ratio of magnesium to calcium preferably being 1:0.2-20.

Another example of the implementation of the invention is that the composition for producing mineralized water contains 5.3 g of zinc chloride and 140 g of calcium chloride per 100 g of magnesium chloride.

The composition of any of the considered above variants of the invention may also additionally contain at least one potassium compound; at that, the mass ratio of magnesium to potassium preferably should amount to 1:0.03-4, while, preferably, the composition contains 4.9 g of zinc sulfate and 10 g of potassium sulfate per 100 g of magnesium sulfate; and/or it, preferably, contains 5.3 zinc chloride, 140 g of calcium chloride, and 12 g of potassium chloride per 100 g of magnesium chloride.

In one more option for the invention implementation, the composition by any of the considered above variants may also additionally contain at least one iodine compound; at that, the mass ratio of magnesium to iodine should preferably amount to 1:0.0002-0.025; and/or at least one selenium compound; at that, the mass ratio of magnesium to selenium should preferably amount to 1:0.00003-0.0018.

The composition by any of the considered above options of implementation has the form of a joint solution of compounds in partially or completely demineralized water, and/or, in a particular case, it is a water solution containing 200 g/l of magnesium sulfate, 10 g/l of zinc sulfate, and 20 g/l of potassium sulfate; and/or containing 20 g/l of magnesium sulfate, 1 g/l of zinc sulfate, and 2 g/l of potassium sulfate; and/or containing 158 g/l of magnesium chloride, 8.3 g/l of zinc chloride, and 222 g/l of calcium chloride; and/or 15.8 g/l of magnesium chloride, 0.83 g/l of zinc chloride, and 22.2 g/l of calcium chloride.

At the same time, the composition by any of the considered variants of implementation may consist of a set of water solutions of individual compounds and/or combined solutions of two or several compounds.

Other additional distinctions of the claimed invention are that the composition may additionally contain at least one component of a tonic and/or flavored and/or vitamin-fortified beverage and/or at least one flavoring agent and/or at least one food coloring and/or at least one food preservative.

Feasibility of the Invention

Achievement of the claimed result, i.e., of improvement of the water quality at the account of a well-balanced content of necessary substances through providing for its concordance with physiological and psychoemotional needs of the human organism, including enhancement of the organism's resistance to stressful situations, is attributable to the following.

As it has been noted above, magnesium participates in regulation of more than 300 tissue and cellular enzymes; it is a co-factor of all enzymes using ATP (adenosine triphosphate) and other triphosphates as substrates. This element is necessary for the regulation of carbohydrate, lipid, nucleic acid, and protein metabolism. Magnesium is playing an important role in the regulation of neuromuscular cardiac activity and maintaining of normal heart rhythm; it is the only natural calcium antagonist as regards excessive pathogenic penetration of the latter into nerve cells, which develops in several neuro- and psychopathological conditions. Deficiency of magnesium intake from food and water can cause arrhythmia, as well as muscular tremor, convulsions, muscular weakness, and so-called “chronic fatigue syndrome”, alongside numerous disturbances of somatic functions of the organism; the level of depressive states which anti-depressants sometimes fail to cope with, is also going up. These states are aggravated by the enhanced level of present time social stresses.

Zinc, in its turn, is involved in the activation of more than 200 vital enzymes, most of which provide for functioning or the nervous system. In the cerebrum (especially the hippocampus), zinc acts as the inter-neuronic transmitter coupled with glutamatergic signalization. It has its own neuron receptors (GPR39), which can initiate powerful biochemical pro-adaptive cascades through the CREB express factor and the BDNF neurotrophic protein. Zn deficiency in the cerebrum causes depression tendencies (or problematic escape from such states), and emergence of such disorders as apathy, ahedonism, phobias, manias, etc. By recent data, deficiency of Zn is one of the factors of Alzheimer's disease development.

Taking into account that these two components (zinc and magnesium) have no identical points of application, they cannot be exchangeable for human consciousness, and they both are, alongside the well-known “macro-” participants of nervous processes (potassium, sodium, calcium), vitally important for maintaining normal psychoemotional status of a human being. Dissociated salts of Zn and Mg in drinking water, unlike organic salts in food products, are digested more readily and efficiently, which allows to replenish the lack of these components in the human organism in the most efficient way, thus facilitating maintaining normal mentality and corrections of mental disturbances, as well as improvement of the individual psychoemotional status, including enhancement of cognitive capacities and organism's resistance in stressful situations.

It is also known from the prior knowledge that one of the leading factors of the hypoxic (ischemic) damage of brain neurons is the mass penetration of extracellular calcium into brain neurons, caused by the excitotoxic impact of increased glutamate level in the cortex upon NMDA (N-methyl-D-aspartate)-associated calcium channels of the brain cellular membranes. Addition of iodine to drinking water leads to a noticeable reduction of the pathogenic accumulation of Ca²⁺ in neurons, i.e., to enhancement of the brain cells' resistance to anoxia; also, it prevents progress in the processes caused by disadaptation of the organism in extreme environmental conditions, hypoxia of the brain and its irreversible damages, and, consequently, derangement of regulatory systems in the entire organism. At that, an important precondition for the neuro-protective effect of iodine introduced with drinking water is its concurrent enrichment with magnesium and zinc in the claimed range of concentrations. In the absence of the indicated components, the iodine effect does not appear at all or is significantly reduced, specifically affecting the organism's capacity for normalization of the psychoemotional state and enhancement of stress resistance.

Besides the above indicated effects, drinking water enriched with magnesium and zinc ions plays an important physiological role in the provision of neural cellular functions underlying educational and memory processes. This was proved by behavioral experiments in the “elevated plus maze” (EPM) and with the help of the Parsol “forced swimming test” (FS).

Four animal groups, each containing 6 rats, were prepared for testing. For two weeks preceding the experiment, all animals were receiving dry Zn/Mg-deficient food (10% of the normal diet) and drinking water of various compositions.

In a series of tests, the impact of Mg and/or Zn deficiency on the state of psyche characterizing depression propensity and anxiety was assessed along with options for possible corrections of these disturbances through mineralization of drinkable fluids. In standard conditions of animal care, their needs in Mg and Zn are fully covered with special food, while drinking water has virtually no Mg and Zn cations (concentrations of Zn and Mg amount to 0.03 and 0.2 mg/l, correspondingly). To create dietary deficiency of Mg and Zn, a special composition of food containing no more than 10% of the necessary amounts of these metals was developed, and all tested animals had been consuming it for 21 days. One group of the animals was additionally given water with compensating amounts of Mg only (60 mg/l); another part was receiving compensation of only Zn (5 mg/l), while the third group was receiving water where both cations were present in the amounts of 60 and 5 mg/l, respectively. The control group was receiving standard food and tap water.

At the end of the preparation period, animals of all groups were tested on the matter of depression (the Parsol forced swimming test (FS) for 10 minutes) and on the matter of anxiety (the elevated plus maze (EPM) for 5 minutes). The animals were tested behaviorally. In the FS test, parameters characterizing formation of depression were evaluated: increased ratio of the time of passive swimming to the time of active swimming and the increased percentage of the immobilization time. In the EPM test, indexes of anxiety and depression-like state were: the reduced number of exits and the time of staying in the open sleeves, and increase of the number and duration of “fading” states.

It was shown that: food deficiency of Zn and Mg on the background of using non-mineralized (tap) drinking water in the course of 2 weeks resulted in serious disturbances in the behavioral characteristics indicating the development of depressive states. At that, correction of Mg deficiency only by drinking water improved behavioral characteristics in the EPM test but had no significant impact on the depression detected in the FS test. In its turn, correction of Zn deficiency only through drinking water partially improved the behavioral status in both tests. Whereas the use of drinking water correcting both Zn and Mg deficiency completely prevented psychic disorders caused by the deficiency of these metals in food, as long as no difference with the control group were registered. This fact confirms the positive effect of a well-balanced combined presence of these elements in drinking water.

An important parameter characterizing magnesium and zinc status of the organism is the consumption-to-excretion ratio of these elements. It has been discovered that only at the claimed concentrations of zinc and magnesium in drinking water, their excretion from the organism decreases, thus facilitating provision of the organism with physiologically adequate amounts of these elements. Excess of the mass content of zinc above the values indicated in the independent claims of the formula causes anemia through suppression of oxidation processes in the organism, while the doses of magnesium exceeding the values indicated in the formula may, in addition to the well-known laxative effect, cause general distress, apathy, drowsiness, and cocaine-like effect up to complete anesthesia. The content of magnesium and zinc below the limits indicated in the independent claims of the formula neutralizes the positive effect of their use, while reduction of the concentration of one of the components induces the above discussed symptoms typical for the lack of these components.

Therefore, only the complex of essential indications stated in the independent claims of the invention formula provides for the achievement of the stipulated result. At that, both the artificially mineralized drinking water and the composition for its preparation are subject to the same inventive idea, have the same task, and are focused on achieving the same result.

The inventive features indicated in the dependent claims of the invention formula and concerning enrichment of drinking water with other elements are targeted at receiving additional efficiency by means of increasing its physiological value and adaptogenic characteristics.

The drinking water with the proposed range of concentrations of the dissolved compounds has a pleasant taste, no sediments, and no odor.

This is confirmed by experiments performed on five rats. The rats were offered four compositions of drinking water: a) water containing 40 mg/l of magnesium and 4 mg/l of zinc, (water 1); b) water 1 with added 15 mg/l of potassium (K₂SO₄), 60 mg/l of calcium (CaCl₂.2H₂O), 50 μg/l of iodine (KIO₃), 1 mg/l of fluorine (KF), 8 μg/l of selenium (Na₂SeO₄); c) water containing 45 mg/l of magnesium and 3 mg/l of zinc with addition of 10 mg/l of potassium (KCl); d) water containing 10 mg/l of magnesium, 4 mg/l of zinc, 70 mg/l of calcium (CaCl₂), 50 μg/l of iodine (KI), 0.2 mg/l of fluorine (NaF), 8 μg/l of selenium (Na₂SeO₃). The number of approaches of each animal to each of the offered compositions and the total amount of each type of water consumed were assessed. No significant differences in the assessed parameters were registered.

Besides this, organoleptic and gustatory evaluation of the above indicated compositions of water, as well as of those presented in examples 1-6 below (5 persons), no differences among them were registered.

The organoleptic and gustative qualities of water with increased concentrations of zinc and magnesium through introduction of corresponding lactates and/or citrates were satisfactory (5 persons took part in the testing).

Organoleptic and gustative testing of different compositions of artificially mineralized drinking water (with different combinations of the abovementioned additions) subjected to carbonation by carbon dioxide or oxygen, and/or with addition of sodium benzoate and/or with addition of a mixture of water-soluble vitamins (vitamins C, B1, B6, and/or with addition of citric acid and malic acid and/or sodium citrate and/or with addition of several food additives (food sweetening agents; water-soluble food beta-carotene; fruit essences). Testing results (5 persons) were satisfactory. Addition of one or several food colors did not affect the gustative qualities of the prepared compositions. Producing food and drinks (soups, coffee, bakery; dissolution of ready-to-go beverage powders) using different compositions of the artificially mineralized drinking water did not degrade the gustative qualities of the cooked products.

Several examples of tested examples of artificially mineralized drinking water and compositions for its preparation under this invention are shown below.

### EXAMPLE 1

The initial water contains 10 mg/l of magnesium and 1 mg/l of zinc. For preparation of water containing 40 mg/l of magnesium and 4 mg/l of zinc, we add to 1 liter of the initial water:

1. Magnesium compound(s) (one of the options):
1.1. MgCl₂.6H₂O: 253.7 mg
1.2. MgSO₄.7H₂O: 307.5 mg
1.3. 126.9 mg of MgCl₂.6H₂O+153.8 mg of MgSO₄.7H₂O

2. Zinc compound(s) (one of the options):
2.1. ZnCl₂: 6.25 mg
2.2. ZnSO₄.7H₂O: 13.19 mg
2.3. 3.13 mg of ZnCl₂+6.60 mg of ZnSO₄.7H₂O

### EXAMPLE 2

The initial water is totally demineralized (distilled or purified by the method of reverse osmosis). For preparation of water containing 40 mg/l of magnesium, 4 mg/l of zinc, 15 mg/l of potassium, 60 mg/l of calcium, 50 μg/l of iodine, 1 mg/l of fluorine, 8 μg/l of selenium we add to 1 liter of the initial water:

1. Magnesium compound(s) (one of the options)
1.1. MgCl₂.6H₂O: 338.3 mg
1.2. MgSO₄.7H₂O: 410.0 mg
1.3. 169.2 mg of MgCl₂.6H₂O+205.0 mg of MgSO₄.7H₂O

2. Zinc compound(s) (one of the options)
2.1. ZnCl₂: 8.33 mg
2.2. ZnSO₄.7H₂O: 17.59 mg
2.3. 4.17 mg ZnCl₂+8.80 mg ZnSO₄.7H₂O

3. Potassium compound (one of the options)
3.1. KCl: 28.63 mg
3.2. K₂SO₄: 33.43 mg
3.3. KHCO₃: 38.43 mg

4. Calcium compound (one of the options)
4.1. CaCl₂: 166.3 mg
4.2. CaCl₂.2H₂O: 220.2 mg
4.3. CaCl₂.6H₂O: 328.0 mg

5. Iodine compound (one of the options)
5.1. KI: 65.4 μg
5.2. KIO₃: 84.3 μg

6. Fluorine compound (one of the options)
6.1. NaF: 2.21 mg
6.2. KF: 3.05 mg

7. Selenium compound (one of the options)
7.1. Na₂SeO₃: 17.52 μg
7.2. Na₂SeO₄: 19.14 μg

### EXAMPLE 3

The composition for preparation of 1000 liters of artificially mineralized drinking water containing (taking into account the dozing error) 35-45 mg/l of magnesium, 3-5 mg/l of zinc, 8-10 mg/l of potassium, from water initially distilled or purified by the method of reverse osmosis (one of the following options):

1. One liter of the water solution of the following compounds in the following amounts:
1.1. MgSO₄.7H₂O: 410 g
1.2. ZnSO₄.7H₂O: 17.6 g
1.3. K₂SO₄: 20 g

2. One liter of the water solution of the following compounds in the following amounts:
2.1. MgCl₂.6H₂O: 338 g
2.2. ZnCl₂: 8.3 g
2.3. KCl: 17.2 g

3. One liter of the water solution of the following compounds in the following amounts:
3.1. MgSO₄.7H₂O: from 0 to 410 g
3.2. MgCl₂.6H₂O: calculated using the formula: A=8.45*(40−0.09756*B). where A is the amount of MgCl₂.6H₂O (g), and B is the amount of MgSO₄.7H₂O (g)
3.3. ZnSO₄.7H₂O: from 0 to 17.6 g
3.4. ZnCl₂: calculated using the formula: C=2.075*(4−0.22727*D), where C is the amount of ZnCl₂ (g), and D is the amount of ZnSO₄.7H₂O (g)
3.5.K₂SO₄: OT 0 [symbol] O 20 g
3.6. KCl: calculated using the formula: E=1.911*(9−0.45*F). where E is the amount of KCl (g), and F is the amount of K₂SO₄(g)

### EXAMPLE 4

The composition for preparation of 1000 liters of artificially mineralized drinking water containing (taking into account the dozing error) 35-45 mg/l of magnesium, 3-5 mg/l of zinc, 8-10 mg/l of potassium from water initially distilled or purified by the method of reverse osmosis:
   10 ml of the composition prepared in accordance with p.1, p.2, or p.3 of the EXAMPLE 3 diluted 10 times with water.

### EXAMPLE 5

The composition for preparation of 1000 liters of artificially mineralized drinking water containing (with consideration of the dozing error) 35-45 mg/l of magnesium, 3-5 mg/l of zinc, 70-90 mg/l of calcium, from water initially distilled or purified by the method of reverse osmosis (one of the alternatives below):

1. One liter of the combined water solution of the following compounds in the following amounts:
1.1. MgCl₂.6H₂O: 338 g
1.2. ZnCl₂: 8.3 g
1.3. CaCl₂.6H₂O: 438 g or CaCl₂.2H₂O: 294 g or CaCl₂: 222 g

2. A set of the following water solutions:
SOLUTION 1 (magnesium): One liter of the solution containing (variants):
   338 g of MgCl₂.6H₂O
   410 g of MgSO₄.7H₂O
   169 g of MgCl₂.6H₂O+205 g of MgSO₄.7H₂O
SOLUTION 2 (zinc): One liter of the solution containing (variants):
   8.3 g ZnCl₂
   17.6 g ZnSO₄.7H₂O
   4.2 g ZnCl₂+8.8 g ZnSO₄.7H₂O
SOLUTION 3 (calcium): One liter of the solution containing (variants):
   438 g CaCl₂.6H₂O
   294 g CaCl₂.2H₂O
   222 g CaCl₂

3. A set of the following water solutions:
SOLUTION 1 (magnesium+zinc): One liter of the solution containing:
   338 g of MgCl₂.6H₂O or 410 g of MgSO₄.7H₂O
   8.3 g of ZnCl₂ or 17.6 g of ZnSO₄.7H₂O
SOLUTION 2 (calcium): One liter of the solution containing (variants):
   438 g of CaCl₂.6H₂O
   294 g of CaCl₂.2H₂O
   222 g of CaCl₂

4. A set of the following water solutions:
SOLUTION 1 (magnesium): One liter of the solution containing (variants):
   338 g of MgCl₂.6H₂O
   410 g of MgSO₄.7H₂O
   169 g of MgCl₂.6H₂O+205 g of MgSO₄.7H₂O
SOLUTION 2 (calcium+zinc): One liter of the solution containing:
   438 g of CaCl₂.6H₂O or 294 g of CaCl₂.2H₂O or 222 g of CaCl₂
   8.3 g ZnCl₂

### EXAMPLE 6

The composition for preparation of 1 liter of artificially mineralized drinking water containing (with consideration of dozing error) 35-45 mg/l of magnesium, 3-5 mg/l of zinc, 70-90 mg/l of calcium, from water initially distilled or purified by the method of reverse osmosis (one of the following options):

1. 10 ml of the composition prepared in accordance with p.1 of EXAMPLE 5 (combined solution of magnesium, zinc and calcium salts) diluted 10 times with water

2. A set of diluted water solutions prepared according to pp. 2, 3, or 4 of EXAMPLE 5 (10 ml of each solution diluted 10 times).

The examples presented above do not embrace all possible options for artificially mineralized drinking water and compositions for its preparation described by the formula but merely serve as illustrations of possible forms of realization of the proposed group of inventions which allow to expand the assortment of beverages of general tonic and revitalizing effect.

The possibility of objective manifestations of technical results from using the invention is confirmed by reliable data presented in the examples illustrating the invention and by the results of experimental studies.

The artificially mineralized drinking water enriched with balanced mineral additives prepared in accordance with the invention, as well as and the composition for its preparation, meet the physiological and psychoemotional needs of the organism, including provision of enhanced stress resistance of the organism and normalization of the psychoemotional status.

1. The artificially mineralized drinking water containing water and water-soluble compounds of magnesium and zinc is wherein it includes at least one compound of magnesium and zinc, the concentrations of magnesium and zinc being 5-65 mg/l and 1-5 mg/l, respectively.

2. The water by claim 1, wherein as water-soluble compounds of magnesium and zinc it contains chlorides and/or sulfates.

3. The water by claim 1, wherein the concentration of magnesium is 30-50 mg/l, while the concentration of zinc is 3-5 mg/l.

4. The water by claim 1, wherein it additionally contains at least one calcium compound, with calcium concentration being 10-100 mg/l.

5. The water by claim 4, wherein the concentration of magnesium is 35-45 mg/l, of zinc—3.5-4.5 mg/l, and of calcium—70-90 mg/l.

6. The water by claim 1, wherein it additionally contains at least one fluorine compound, the concentration of fluorine being 0.1-1.5 mg/l.

7. The water by claim 1, wherein it additionally contains at least one selenium compound, the concentration of selenium amounting to 2-9 μg/l.

8. The water by claim 1, wherein it additionally contains at least one iodine compound, the concentration of iodine amounting to 10-125 μg/l.

9. The water by claim 1, wherein it additionally contains water-soluble compounds of sodium and/or potassium, preferably their hydrogen carbonates and/or chlorides and/or sulfates.

10. The water by claim 1, wherein it additionally contains dissolved oxygen or carbon dioxide.

11. The water by claim 1, wherein it is produced by changing the number and/or concentrations of chemical elements present in the initial natural, partially or completely demineralized water.

12. The water by claim 1, wherein it additionally contains at least one component of a tonic and/or flavored and/or vitamin-fortified beverage and/or at least one flavoring agent and/or at least one food coloring and/or at least one food preservative.

13. The water by claim 1, wherein it is used for preparation of beverages and food products.

14. The composition for preparation of artificially mineralized drinking water on the basis of water-soluble compounds of magnesium and zinc is wherein it contains at least one magnesium compound and at least one zinc compound, the mass ratio of magnesium to zinc being 1:0.02-1.

15. The composition by claim 14, wherein sulfates of magnesium and zinc are used as the water-soluble compounds of magnesium and zinc.

16. The composition by claim 15, wherein for each 100 g of magnesium sulfate it contains 4.9 g of zinc sulfate.

17. The composition by claim 16, wherein chlorides of magnesium and zinc are used as water-soluble compounds of magnesium and zinc.

18. The composition by claim 17, wherein for each 100 g of magnesium chloride it contains 5.3 g of zinc chloride.

19. The composition by claim 14, wherein it additionally contains at least one calcium compound, the mass ratio of magnesium to calcium being 1:0.2-20.

20. The composition by claim 19, wherein for each 100 g of magnesium chloride it contains 5.3 g of zinc chloride and 140 g of calcium chloride.

21. The composition by claim 14, wherein it additionally contains at least one potassium compound, the mass ratio of magnesium to potassium being 1:0.03-4.

22. The composition by claim 21, wherein for each 100 g of magnesium sulfate it contains 4.9 g of zinc sulfate and 10 g of potassium sulfate.

23. The composition by claim 21, wherein for each 100 g of magnesium chloride it contains 5.3 g of zinc chloride, 140 g of calcium chloride, and 12 g of potassium chloride.

24. The composition by claim 14, wherein it additionally contains at least one iodine compound, the mass ratio of magnesium to iodine being 1:0.0002-0.025.

25. The composition by claim 14, wherein it additionally contains at least one selenium compound, the mass ratio of magnesium to selenium being 1:0.00003-0.0018.

26. The composition by claim 14, wherein it is a united solution of compounds in partially or completely demineralized water.

27. The composition by claim 26, wherein it is a water solution containing 200 g/l of magnesium sulfate, 10 g/l of zinc sulfate, and 20 g/l of potassium sulfate.

28. The composition by claim 26, wherein it is a water solution containing 20 g/l of magnesium sulfate, 1 g/l of zinc sulfate, and 2 g/l of potassium sulfate.

29. The composition by claim 26, wherein it is a water solution containing 158 g/l of magnesium chloride, 8.3 g/l of zinc chloride, and 222 g/l of calcium chloride.

30. The composition by claim 26, wherein it is a water solution containing 15.8 g/l of magnesium chloride, 0.83 g/l of zinc chloride and 22.2 g/l of calcium chloride.

31. The composition by claim 14, wherein it is a set of water solutions of particular compounds and/or combined solutions of two or several compounds.

32. The composition by claim 14, wherein it additionally contains at least one component of a tonic and/or flavored and/or vitamin-fortified beverage and/or at least one flavoring agent and/or at least one food coloring and/or at least one food preservative.
